(19) United States
(12) Patent Application Publication
(10) Pub. No.: US 2007/0142090 A1
(43) Pub. Date: Jun. 21, 2007

(54) Sharing information in a network

(76) Inventors: Tobias D. Rydenhag, Malmo (SE); Hans M. Kretz, Lund (SE); Magnus P. Hansson, Lund (SE)

Correspondence Address: HARRITY SNYDER, L.L.P., 11350 RANDOM HILLS ROAD, SUITE 600, FAIRFAX, VA, 22030, US

(21) Appl. No.: 11/300,358

(22) Filed: Dec. 15, 2005

(51) Int. Cl. H04M 1/00; H04B 1/38

(52) U.S. Cl. 455/566

(57) ABSTRACT

A method performed by a mobile terminal may include connecting to a network and receiving information from other mobile terminals via the network. The information may identify songs played by the other mobile terminals. The method may also include displaying information associated with a first one of the songs.

### TECHNICAL FIELD OF THE INVENTION

The invention relates generally to communications and, more particularly, to sharing information between devices.

### DESCRIPTION OF RELATED ART

Communication devices, such as cellular telephones, have become increasingly versatile. For example, cellular telephones often include applications or programs that enable users to obtain information, such as directions to a place of interest, sports scores and weather related information. Communication devices may also include applications that allow users to play music and games. Such applications have made communication devices increasingly important to users.

### SUMMARY

According to one aspect, a method, performed by a first mobile terminal, comprises connecting to a network and receiving information from a plurality of mobile terminals via the network. The information identifies a plurality of songs played by the plurality of mobile terminals. The method also includes displaying information associated with a first one of the songs.

Additionally, the method may comprise downloading the first song.

Additionally, the downloading may comprise downloading the first song from at least one of the plurality of mobile terminals.

Additionally, the method may comprise storing the information identifying the plurality of songs.

Additionally, the method may comprise sorting the information identifying the plurality of songs based on at least one criterion.

Additionally, the method may comprise transmitting a first request for information identifying songs being played or recently played by the plurality of mobile terminals.

Additionally, the method may comprise transmitting additional requests for information identifying songs being played or recently played on a periodic interval.

Additionally, the network may comprise an ad hoc network.

Additionally, the method may comprise transmitting information identifying a second song being played or recently played by the first mobile terminal to at least one of the plurality of mobile terminals.

According to another aspect, a mobile terminal is provided. The mobile terminal comprises a memory and logic configured to receive information from at least one other mobile terminal via a network, the information identifying a first song played by the at least one other mobile terminal. The logic is also configured to store the information identifying the first song in the memory. The mobile terminal also comprises a display configured to display information associated with the first song.

Additionally, the mobile terminal may comprise a transmitter configured to transmit a request to download the first song and a receiver configured to receive a file containing the first song in response to the request.

Additionally, the transmitter may be configured to transmit the request to the at least one other mobile terminal.

Additionally, the at least one other mobile terminal may comprise a plurality of mobile terminals, and the memory may be configured to store information identifying a plurality of songs based on information received from the plurality of mobile terminals.

Additionally, the logic may be configured to sort the information identifying the plurality of songs based on at least one criterion.

Additionally, the logic may be configured to request information identifying songs being played or recently played by the at least one other mobile terminal, receive information identifying a plurality of songs being played or recently played by the at least other mobile terminal in response to the request, retrieve at least some of the plurality of songs and play the retrieved songs.

Additionally, the logic may be configured to forward information identifying a song being played or recently played by the mobile terminal. The mobile terminal may also comprise a transmitter configured to receive the forwarded information and transmit the forwarded information to the at least one other mobile terminal via the network.

Additionally, the logic may be configured to receive additional information from a plurality of mobile terminals over a period of time, the additional information identifying a plurality of songs, and store the additional information identifying the plurality of songs in the memory.

Additionally, the logic may be configured to dynamically update a playlist based on the received additional information.

According to a further aspect, a computer-readable medium having stored thereon a plurality of sequences of instructions is provided. The instructions, when executed by at least one processor, cause the processor to request information from a plurality of mobile terminals via a network and receive information from the plurality of mobile terminals via the network, the information identifying a plurality of songs played by the plurality of mobile terminals. The instructions further cause the processor to store information associated with the plurality of songs in a memory.

Additionally, the computer-readable medium may further comprise instructions for causing the processor to output information associated with a first one of the plurality of songs to a display.

Additionally, the computer-readable medium may further comprise instructions for causing the processor to periodically request additional information identifying songs being played or recently played by the plurality of mobile terminals via the network, receive information in response to the request and store the received information.

Additionally, the computer-readable medium may further comprise instructions for causing the processor to dynamically update a playlist based on information received in response to the periodic requests.

According to yet another aspect, a network device comprises means for connecting to a network and means for receiving information from a plurality of other network devices via the network, the information identifying a plurality of songs played by the plurality of network devices. The network device also comprises means for displaying information associated with at least some of the plurality of songs.

Additionally, the network device may further comprise means for sorting the received information, means for storing the sorted information and means for dynamically updating the stored information based on additional information received from the plurality of network devices over a period of time.

According to still another aspect, a mobile terminal comprises logic configured to generate a request for information identifying songs played by a plurality of network devices and a transmitter configured to transmit the request to the plurality of network devices via a network. The mobile terminal also comprises a receiver configured to receive information from at least some of the plurality of network devices via the network in response to the request, the received information identifying songs played by the at least some of the network devices.

Additionally, the mobile terminal may comprise a memory and a display, wherein the logic is further configured to store the received information in the memory and output at least some of the received information to the display.

Additionally, the transmitter may be configured to transmit the request at periodic intervals and the logic may be configured to dynamically update a listing of songs based on information received in response to the requests transmitted at periodic intervals.

Other features and advantages of the invention will become readily apparent to those skilled in this art from the following detailed description. The embodiments shown and described provide illustration of the best mode contemplated for carrying out the invention. The invention is capable of modifications in various obvious respects, all without departing from the invention. Accordingly, the drawings are to be regarded as illustrative in nature, and not as restrictive.

### BRIEF DESCRIPTION OF THE DRAWINGS

Reference is made to the attached drawings, wherein elements having the same reference number designation may represent like elements throughout.

FIG. 1 is a diagram of an exemplary system in which methods and systems consistent with the invention may be implemented;

FIG. 2 is a diagram of an exemplary mobile terminal according to an implementation consistent with the invention;

FIG. 3 is a flow diagram illustrating exemplary processing by mobile terminals consistent with the invention;

FIG. 4 is a block diagram illustrating a table stored in the mobile terminal of FIG. 2 according to an exemplary implementation; and

FIG. 5 is a flow diagram illustrating exemplary processing by a mobile terminal consistent with the invention.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

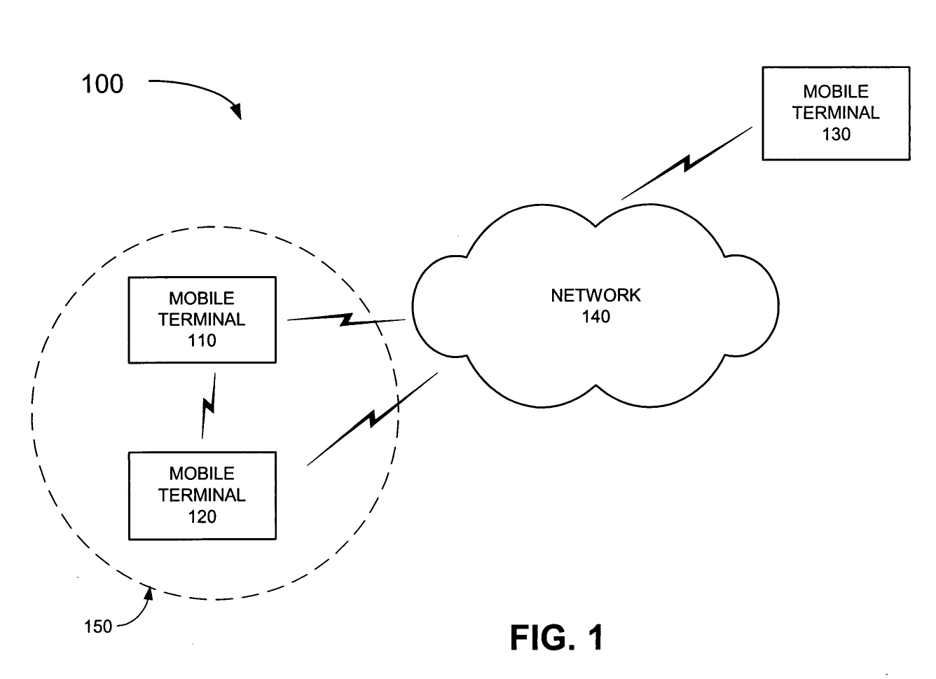

FIG. 1 is a diagram of an exemplary system 100 in which methods and systems consistent with the invention may be implemented. System 100 may include mobile terminals 110, 120 and 130 connected via network 140. Only three mobile terminals are shown for simplicity. It should be understood that system 100 may include other numbers of mobile terminals.

The invention is described herein in the context of a mobile terminal. As used herein, the term “mobile terminal” may include a cellular radiotelephone with or without a multi-line display; a Personal Communications System (PCS) terminal that may combine a cellular radiotelephone with data processing, facsimile and data communications capabilities; a personal digital assistant (PDA) that can include a radiotelephone, pager, Internet/Intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

Network 140 may include one or more networks including a cellular network, a satellite network, the Internet, a telephone network, such as the Public Switched Telephone Network (PSTN), a metropolitan area network (MAN), a wide area network (WAN), a local area network (LAN) or another type of network. Mobile terminals 110, 120 and 130 may communicate with each other over network 140 via wired, wireless or optical connections.

In an exemplary implementation, network 140 includes a cellular network that uses components for transmitting data to and from mobile terminals 110, 120 and 130. Such components may include base station antennas (not shown) that transmit and receive data from mobile terminals within their vicinity. Such components may also include base stations (not shown) that connect to the base station antennas and communicate with other devices, such as switches and routers (not shown) in accordance with known techniques.

System 100 may also include an ad hoc network that enables mobile terminals in system 100 to locate and communicate with one another. For example, system 100 may include an ad hoc network 150, shown by the dashed circle in FIG. 1. Ad hoc network 150 may include mobile terminals 110 and 120. It should be understood that ad hoc network 150 may include additional components and additional mobile terminals (not shown).

In an exemplary implementation, mobile terminals 110-130 may employ “beacons” as a way in which one mobile terminal may locate another mobile terminal in ad hoc network 150. A beacon is a transmission that can be generated by one mobile terminal and may be received by some or all of the mobile terminals within a transmission range. That is, the beacon may be a broadcast transmission rather than a transmission to any particular mobile terminal/node. The beacon may be used to initiate communications between two mobile terminals, as described in more detail below.

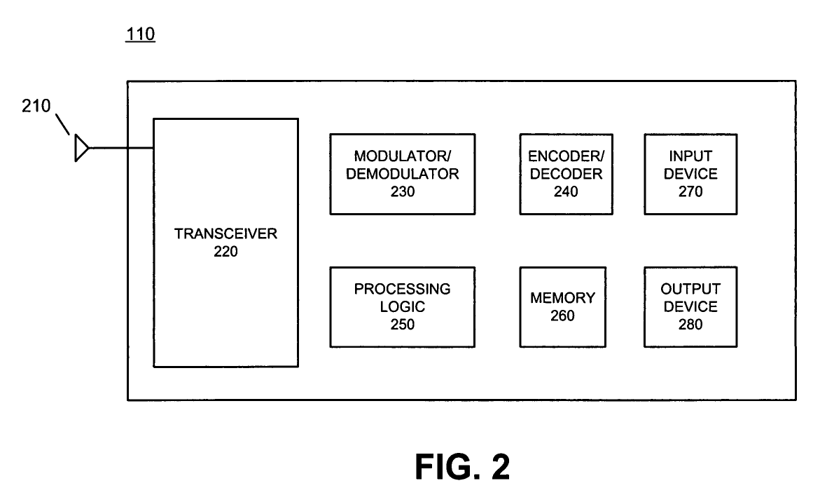

FIG. 2 is a diagram of mobile terminal 110 according to an exemplary implementation consistent with the invention. It should be understood that mobile terminals 120 and 130 may include the same or similar elements and may be configured in the same or a similar manner.

Mobile terminal 110 may include one or more radio frequency (RF) antennas 210, transceiver 220, modulator/demodulator 230, encoder/decoder 240, processing logic 250, memory 260, input device 270 and output device 280. These components may be connected via one or more buses (not shown). In addition, mobile terminal 110 may include one or more power supplies (not shown). One skilled in the art would recognize that the mobile terminal 110 may be configured in a number of other ways and may include other or different elements.

RF antenna 210 may include one or more antennas capable of transmitting and receiving RF signals. In one implementation, RF antenna 210 may include one or more directional and/or omni-directional antennas. Transceiver 220 may include components for transmitting and receiving information via RF antenna 210. In an alternative implementation, transceiver 220 may take the form of separate transmitter and receiver components, instead of being implemented as a single component. Modulator/demodulator 230 may include components that combine data signals with carrier signals and extract data signals from carrier signals. Modulator/demodulator 230 may include components that convert analog signals to digital signals, and vice versa, for communicating with other devices in mobile terminal 110.

Encoder/decoder 240 may include circuitry for encoding a digital input to be transmitted and for decoding a received encoded input. Processing logic 250 may include a processor, microprocessor, an application specific integrated circuit (ASIC), field programmable gate array (FPGA) or the like. Processing logic 250 may execute software programs or data structures to control operation of mobile terminal 110. Memory 260 may include a random access memory (RAM) or another type of dynamic storage device that stores information and instructions for execution by processing logic 250; a read only memory (ROM) or another type of static storage device that stores static information and instructions for use by processing logic 250; and/or some other type of magnetic or optical recording medium and its corresponding drive. Instructions used by processing logic 250 may also, or alternatively, be stored in another type of computer-readable medium accessible by processing logic 250. A computer-readable medium may include one or more memory devices and/or carrier waves.

Input device 270 may include any mechanism that permits an operator to input information to mobile terminal 110, such as a microphone, a keyboard, a keypad, a mouse, a pen, voice recognition and/or biometric mechanisms, etc. Output device 280 may include any mechanism that outputs information to the operator, including a display, a speaker, a printer, etc. Output device 280 may also include a vibrator mechanism that causes mobile terminal 110 to vibrate.

Mobile terminal 110, consistent with the invention, may perform processing associated with, for example, sharing music-related information with other devices, such as other mobile terminals. Mobile terminal 110 may perform these operations in response to processing logic 250 executing sequences of instructions contained in a computer-readable medium, such as memory 260. It should be understood that a computer-readable medium may include one or more memory devices and/or carrier waves. Execution of sequences of instructions contained in memory 260 causes processing logic 250 to perform acts that will be described hereafter. In alternative embodiments, hard-wired circuitry may be used in place of or in combination with software instructions to implement processes consistent with the invention. Thus, implementations consistent with the invention are not limited to any specific combination of hardware circuitry and software.

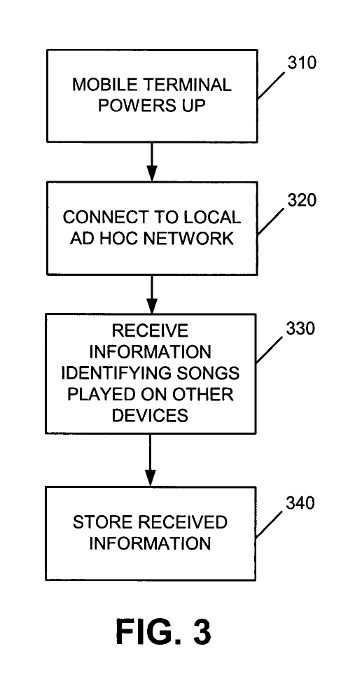

FIG. 3 is a flow diagram illustrating exemplary processing by mobile terminals, such as one or more of mobile terminals 110-130, in an implementation consistent with the invention. Processing may begin when a mobile terminal, such as mobile terminal 110, powers up (act 310). Assume that the user of mobile terminal 110 wishes to exchange music-related information with other parties. For example, the user of mobile terminal 110 may wish to receive information regarding songs being played or recently played by other mobile terminals in its vicinity or playlists from other mobile terminals. The user of mobile terminal 110 may also wish to allow other mobile terminals to receive information identifying songs that mobile terminal 110 plays. In this case, users of mobile terminals, such as mobile terminals 110-130 may form a local ad hoc network or connect to an existing ad hoc network, such as ad hoc network 150 (act 320).

For example, in one implementation, after mobile terminal 110 powers up, the user of mobile terminal 110 may initiate an application program associated with sharing music-related information with other mobile terminals. The user may initiate the application via, for example, input device 270 (FIG. 2), which may include pressing a control button or keypad input on mobile terminal 110. After initiating the music information sharing program, mobile terminal 110 may send a beacon transmission, as described above. Other mobile terminals in the vicinity of mobile terminal 110 may receive the beacon signal and exchange information with mobile terminal 110, such as identifiers that may be used to facilitate communications between mobile terminal 110 and the other mobile terminals that receive the beacon. Assume that mobile terminal 120 is in the vicinity of mobile terminal 110 and receives the beacon signal from mobile terminal 110. Further assume that mobile terminal 110 and mobile terminal 120 are able to communicate with each other and form part of ad hoc network 150.

In alternative implementations, mobile terminal 110 may be configured to communicate with other mobile terminals using predetermined signaling upon powering up. In this case, when mobile terminal 110 powers up, mobile terminal 110 may perform a synchronization procedure to enable mobile terminal 110 to communicate with other mobile terminals in its vicinity, such as mobile terminal 120, via ad hoc network 150. In other implementations, no synchronization may be needed.

In each case, assume that mobile terminal 110 can communicate with mobile terminal 120. Further assume that the user of mobile terminal 110 wishes to retrieve information from other mobile terminals in its vicinity, such as information regarding what songs are being played or have recently been played by other mobile terminals in ad hoc network 150. In this case, mobile terminal 110 may send a request to other mobile terminals in ad hoc network 150.

Assume that mobile terminal 120 receives the request. Mobile terminal 120 may then determine whether it is currently playing a song. If mobile terminal 120 is currently playing a song, mobile terminal 120 may send information to mobile terminal 110 identifying the song. For example, mobile terminal 120 may send information indicating the song title and the performer/band playing the song. Mobile terminal 120 may alternatively send an identifier, such as a unique group of alphanumeric characters, that may be used by mobile terminals to identify a particular song.

In each case, mobile terminal 110 may receive the information identifying the song (act 330). Mobile terminal 110 may similarly receive information from other mobile terminals in ad hoc network 150 (not shown) in a similar manner.

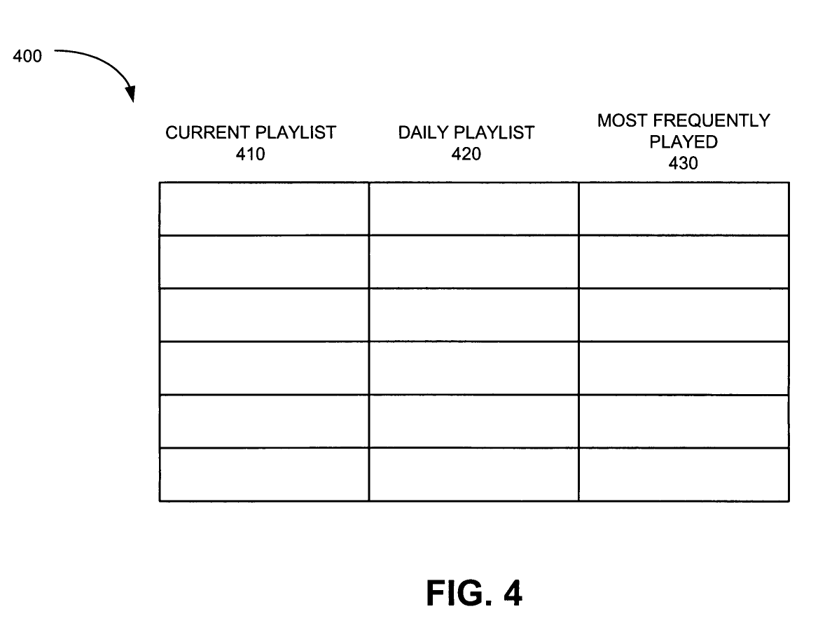

Mobile terminal 110 may then store the song identification information (act 340). In an exemplary implementation, mobile terminal 110 may store the information in table form in, for example, memory 260 (FIG. 2). FIG. 4 illustrates an exemplary table 400 used to store song identification information in mobile terminal 110. Referring to FIG. 4, table 400 may include a current playlist field 410, a daily playlist field 420 and a most frequently played field 430. Current playlist field 410 may store information identifying songs played by mobile terminals in ad hoc network 150. For example, current playlist field 410 may store a number of entries that identify songs currently being played by other mobile terminals in ad hoc network 150. Alternatively, current playlist field 410 may store a number of entries that identify songs that have been recently played, such as within a predetermined time (e.g., one hour), by mobile terminals in ad hoc network 150.

Daily playlist field 420 may include information identifying songs that were played by other mobile terminals in ad hoc network 150 over some predetermined period of time. For example, daily playlist field 420 may include information received by mobile terminal 110 over, for example, one work day (e.g., 8:00 AM to 5:00 PM), one 24 hour period, etc.

Most frequently played field 430 may include information identifying the most frequently played song in, for example, daily playlist field 420. In this case, processing logic 250 may sort the songs stored in daily playlist field 420 based on, for example, the number of entries for each particular song. The most frequently played song may be listed as the first entry in most frequently played field 430. The user of mobile terminal 110 may set one or more criterion for storing the song identification information via input device 270. For example, in one implementation, the music information sharing program may provide a menu that lists a number of options with respect to sorting the received song identification information. The user may then select one or more criterion based on the user's particular preferences.

Fields 410-430 illustrated in FIG. 4 are exemplary only. It should be understood that table 400 may include additional fields associated with the obtained song information based on the particular user's preferences. For example, table 400 may include a least frequently played list that identifies songs that were less frequently played by other mobile terminals in ad hoc network 150, songs grouped by band/performer or songs ranked or grouped according to other criteria.

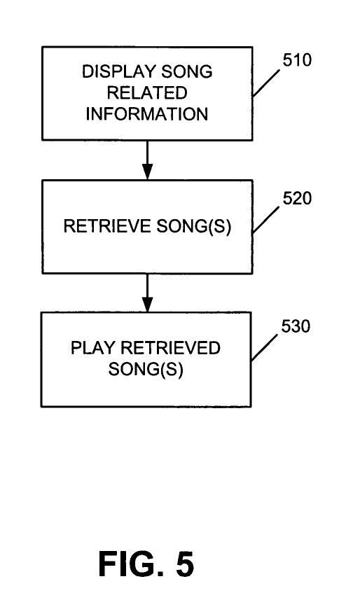

FIG. 5 is a flow diagram illustrating exemplary processing by mobile terminal 110 associated with displaying song information and retrieving songs. Mobile terminal 110, consistent with the invention, may allow the user of mobile terminal 110 to view the song identification information stored in table 400, via, for example, output device 280. Output device 280 may include a display screen that allows the user to view text data associated with the stored songs. In an exemplary implementation, mobile terminal 110 may be placed in an “active mode” in which output device 280 (e.g., a display associated with mobile terminal 110) displays titles and/or performers of songs stored in current playlist field 410 as they are received by mobile terminal 110 (act 510). Alternatively, mobile terminal 110 may be placed in an inactive mode in which the songs obtained over a period of time, such as one work day, may be stored and displayed to the user of mobile terminal 110 at a later time.

For example, the user of mobile terminal 110 may retrieve the information stored in table 400, such as the information in daily playlist field 420. In this case, the user of mobile terminal 110 may press one or more function keys or keys on a keypad of mobile terminal 110 to retrieve the stored information. In this manner, the user of mobile terminal 110 may browse through a listing of songs, such as the daily playlist field 420, after coming home from work, school, etc., and allows the user to be aware of songs that other users listened to during that day.

Mobile terminal 110 may also be configured in an “active listening” mode. In this mode, mobile terminal 110 may retrieve the songs identified in table 400 (act 520). For example, mobile terminal 110 may obtain one of the songs identifiers stored in table 400 and forward it to an online music store via, for example, network 140. The online music store may receive the song identifier and download a file, such as an MPEG audio layer 3 (MP3) file, a wav file, etc., that contains the song to mobile terminal 110. In this case, the online music store may request payment information, such as credit card information, from the user of mobile terminal 110 or mobile terminal 110 may automatically forward the payment information. In still other alternatives, mobile terminal 110 may have an account with the online music store and mobile terminal 110 may transmit an account identifier with the song identifier to the online music store.

In still further alternatives, mobile terminal 110 may download the desired song that was played by another mobile terminal, such as mobile terminal 120, in a peer-to-peer application with the other mobile terminal. For example, mobile terminal 110 and mobile terminal 120 may execute an application that allows theses mobile terminals to transfer music files between themselves. Alternatively, the application may enlist a third party device, such as a server in network 140 or ad hoc network 150, that is able to upload the song from mobile terminal 120 and then download the song to mobile terminal 110.

In each case, mobile terminal 110 may receive the desired song and then play the retrieved song (act 530). When the song is finished playing, mobile terminal 110 may retrieve the next song stored in, for example, current playlist field 410. In this manner, the user of mobile terminal 110 may obtain a dynamic playlist that changes based on the people that the user of mobile terminal 110 comes in contact with via ad hoc network 150. That is, as the user of mobile terminal 110 comes in contact with other users of mobile terminals in ad hoc network 150, mobile terminal 110 may receive song information and dynamically download songs played by the users of other mobile terminals. Alternatively, mobile terminal 110 may simply dynamically update a listing of songs over a period of time.

Mobile terminal 110 may also be configured to periodically send requests for information regarding songs played by other mobile terminals in ad hoc network 150. Alternatively, each mobile terminal executing the music information program may periodically transmit information identifying songs that the particular mobile terminal is playing without having to receive a request.

In addition, as the user of mobile terminal 110 moves from place to place throughout the day, mobile terminal 110 may form connections to different ad hoc networks over time. In other words, mobile terminal 110 may connect to different ad hoc networks during the day and receive information from other mobile terminals located in the vicinity of mobile terminal 110.

Although not described above, it should be understood that mobile terminal 10 may receive requests for information regarding songs that mobile terminal 10 is playing at the same time mobile terminal 10 is requesting information from other mobile terminals. In this manner, users of mobile terminals 110-130 may share information in a two way manner.

### CONCLUSION

Implementations consistent with the invention allow users to share information identifying songs that the users play. This may help a user discover new music that he/she likes. In addition, aspects consistent with the invention enable a user to obtain and/or share information in a manner that requires little to no input by the user. This helps increase a user's satisfaction level with respect to sharing information.

The foregoing description of the embodiments of the invention provides illustration and description, but is not intended to be exhaustive or to limit the invention to the precise form disclosed. Modifications and variations are possible in light of the above teachings or may be acquired from practice of the invention.

For example, the invention has been described in the context of a mobile terminal sharing music-related information. The invention, however, may be used to share other types of information, such as information identifying video games played by others, information identifying web sites of interest that other users may be accessing, etc.

In addition, the invention has been described as being implemented by mobile terminals connected via an ad hoc network. The invention may be implemented in other devices or systems and/or networks. For example, the network devices may connect to each other using Bluetooth or some other relatively short range connection mechanism. This may help limit the amount of information that a user receives in situations where the user does not want to receive a large amount of information. In still other alternatives, the network devices may connect to each other over a LAN, a virtual LAN (VLAN), a WAN, a intranet, the Internet, a PSTN, etc. The invention may also be implemented by any network device, including a non-mobile device that is able to connect to a network.

Further, while series of acts have been described with respect to FIGS. 3 and 5, the order of the acts may be varied in other implementations consistent with the invention. Moreover, non-dependent acts may be performed in parallel.

It will also be apparent to one of ordinary skill in the art that aspects of the invention, as described above, may be implemented in cellular communication devices/systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as an application specific integrated circuit or a field programmable gate array, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

The scope of the invention is defined by the claims and their equivalents.

What is claimed is:

1. A method performed by a first mobile terminal, comprising:
connecting to a network;
receiving information from a plurality of mobile terminals via the network, the information identifying a plurality of songs played by the plurality of mobile terminals; and
displaying information associated with a first one of the songs.

2. The method of claim 1, further comprising:
downloading the first song.

3. The method of claim 2, wherein the downloading comprises:
downloading the first song from at least one of the plurality of mobile terminals.

4. The method of claim 1, further comprising:
storing the information identifying the plurality of songs.

5. The method of claim 4, further comprising:
sorting the information identifying the plurality of songs based on at least one criterion.

6. The method of claim 1, further comprising:
transmitting a first request for information identifying songs being played or recently played by the plurality of mobile terminals.

7. The method of claim 6, further comprising:
transmitting additional requests for information identifying songs being played or recently played on a periodic interval.

8. The method of claim 1, wherein the network comprises an ad hoc network.

9. The method of claim 1, further comprising:
transmitting information identifying a second song being played or recently played by the first mobile terminal to at least one of the plurality of mobile terminals.

10. A mobile terminal, comprising:
a memory;
logic configured to:
receive information from at least one other mobile terminal via a network, the information identifying a first song played by the at least one other mobile terminal, and
store the information identifying the first song in the memory; and
a display configured to:
display information associated with the first song.

11. The mobile terminal of claim 10, further comprising:
a transmitter configured to:
transmit a request to download the first song; and
a receiver configured to:
receive a file containing the first song in response to the request.

12. The mobile terminal of claim 11, wherein the transmitter is configured to transmit the request to the at least one other mobile terminal.

13. The mobile terminal of claim 10, wherein the at least one other mobile terminal comprises a plurality of mobile terminals, and wherein the memory is configured to:
store information identifying a plurality of songs based on information received from the plurality of mobile terminals.

14. The mobile terminal of claim 13, wherein the logic is further configured to:
sort the information identifying the plurality of songs based on at least one criterion.

15. The mobile terminal of claim 10, wherein the logic is further configured to:
request information identifying songs being played or recently played by the at least one other mobile terminal,
receive information identifying a plurality of songs being played or recently played by the at least one other mobile terminal in response to the request,
retrieve at least some of the plurality of songs, and
play the retrieved songs.

16. The mobile terminal of claim 10, wherein the logic is further configured to:
forward information identifying a song being played or recently played by the mobile terminal, the mobile terminal further comprising:
a transmitter configured to:
receive the forwarded information, and
transmit the forwarded information to the at least one other mobile terminal via the network.

17. The mobile terminal of claim 10, wherein the logic is further configured to:
receive additional information from a plurality of mobile terminals over a period of time, the additional information identifying a plurality of songs, and
store the additional information identifying the plurality of songs in the memory.

18. The mobile terminal of claim 17, wherein the logic is further configured to:
dynamically update a playlist based on the received additional information.

19. A computer-readable medium having stored thereon a plurality of sequences of instructions which, when executed by at least one processor, cause the processor to:
request information from a plurality of mobile terminals via a network;
receive information from the plurality of mobile terminals via the network, the information identifying a plurality of songs played by the plurality of mobile terminals; and
store information associated with the plurality of songs in a memory.

20. The computer-readable medium of claim 19, further comprising instructions for causing the processor to:
output information associated with a first one of the plurality of songs to a display.

21. The computer-readable medium of claim 19, further comprising instructions for causing the processor to:
periodically request additional information identifying songs being played or recently played by the plurality of mobile terminals via the network;
receive information in response to the request; and
store the received information.

22. The computer-readable medium of claim 21, further comprising instructions for causing the processor to:
dynamically update a playlist based on information received in response to the periodic requests.

23. A network device, comprising:
means for connecting to a network;
means for receiving information from a plurality of other network devices via the network, the information identifying a plurality of songs played by the plurality of network devices; and
means for displaying information associated with at least some of the plurality of songs.

24. The network device of claim 23, further comprising:
means for sorting the received information;
means for storing the sorted information; and
means for dynamically updating the stored information based on additional information received from the plurality of network devices over a period of time.

25. A mobile terminal, comprising:
logic configured to:
generate a request for information identifying songs played by a plurality of network devices;
a transmitter configured to:
transmit the request to the plurality of network devices via a network; and
a receiver configured to:
receive information from at least some of the plurality of network devices via the network in response to the request, the received information identifying songs played by the at least some of the network devices.

26. The mobile terminal of claim 25, further comprising:
a memory; and
a display,
wherein the logic is further configured to:
store the received information in the memory, and
output at least some of the received information to the display.

27. The mobile terminal of claim 25, wherein the transmitter is further configured to:
transmit the request at periodic intervals, and
the logic is further configured to:
dynamically update a listing of songs based on information received in response to the requests transmitted at periodic intervals.
